(19) United States
(12) Patent Application Publication
(10) Pub. No.: US 2007/0179797 A1
(43) Pub. Date: Aug. 2, 2007

(54) Method and apparatus for receiving a product notice using a notifier appendage

(76) Inventors: Mark Sedlack, Cuyahoga Falls, OH (US); Addison Brooke Jones, Yorba Linda, CA (US); Jack Ivan Jmaev, Chino, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/517,018

(22) Filed: Sep. 7, 2006

Related U.S. Application Data
(63) Continuation-in-part of application No. 10/615,412, filed on Jul. 7, 2003.
(63) Continuation-in-part of application No. 10/850,476, filed on May 19, 2004.

(51) Int. Cl. G06Q 99/00

(52) U.S. Cl. 705/1

(57) ABSTRACT

A product recall notice receiver that includes a housing with a strap orifice. A receiver si installed in the housing together with antenna, a power source and an indicator.

### RELATED APPLICATIONS

The present application is a continuation-in-part of a parent U.S. patent application Ser. No. 10/615,412, filed on Jul. 7, 2003 by Jack J'maev entitled “Method and Apparatus for Receiving a Product Notice” which is incorporated herein by reference in its entirety; the present application also claims priority to the parent application entitled “METHOD AND APPRATUS FOR RECEIVING A PRODUCT NOTICE USING A NOTIFIER APPENDAGE” by Sedlack et al., Ser. No. 60/715,348 filed on Sep. 7, 2005; this application is also a continuation-in-part of a parent U.S. patent application Ser. No. 10/850,476, filed on May 19, 23004 by Jack J'maev entitled “Method and Apparatus for Product-Centric Delivery of Product User Notices” which is also incorporated herein by reference in its entirety.

### BACKGROUND

There are many products that could benefit from incorporation of a product notice receiver as described in the incorporated reference. However, integration time and effort may prohibit such incorporation. For example, baby car seats and other baby products could truly benefit by having a product recall notice receiver. However, these types of products require mechanical integrity testing prior to introduction into the stream of commerce. As such, a product manufacturer may need to wait until a new product is developed before a recall receiver can be included in the product.

In other products, there may not be a convenient means for including a product notice receiver. For example, an article of furniture (a recliner, for example) may not hav e a convenient surface for incorporation of a product recall receiver. Plush toys are also products that can benefit from a recall receiver, but these products also present an awkward platform for integration of a recall notice receiver. In short, many products exist that could benefit from a product recall receiver if the receiver could be included as an afterthought in the design and production process. Any specific product examples listed here are not intended to limit the scope of the claims appended hereto.

### BRIEF DESCRIPTION OF THE DRAWINGS

Several alternative embodiments will hereinafter be described in conjunction with the appended drawings and figures, wherein like numerals denote like elements, and in which:

FIG. 1 is a pictorial diagram that illustrates one example embodiment of a product notice receiver in the form of a notifier appendage;

FIG. 2 is a pictorial diagram that illustrates one example illustrative use case for a product notice receiver dongle;

FIG. 3 is a pictorial diagram that illustrates one example alternative embodiment of an internal arrangement of a product notice receiver dongle; and

FIG. 4 is a pictorial diagram that illustrates a side assembly view of a product notice receiver dongle.

### DETAILED DESCRIPTION

Applicant has described a novel method for disseminating recall notices to the users of various products. According to the application herein referenced, Applicant describes a product notice receiver that is fashioned to receive a product notice message, including but not limited to a recall notice message. In the referenced applications, Applicant describes a method and apparatus by which a product notice receiver is integrated into a product. Such integration of a product notice receiver into a product results in a product that includes a capability for receiving a product notice message (e.g. the recall notice). As innovative as the method and apparatus for receiving a product notice message in an integrated receiver has been the demonstrated to be, there is incumbent upon the manufacturer the need to the perform substantial re-engineering of a product in order to incorporate a product notice receiver into a particular product.

The present method and apparatus provide for receiving a product notice message, including but not limited to a recall notice message, and a device that is attached to a product by means of a flexible strap. The device attached to the product in this manner is referred to as a “notifier” appendage.

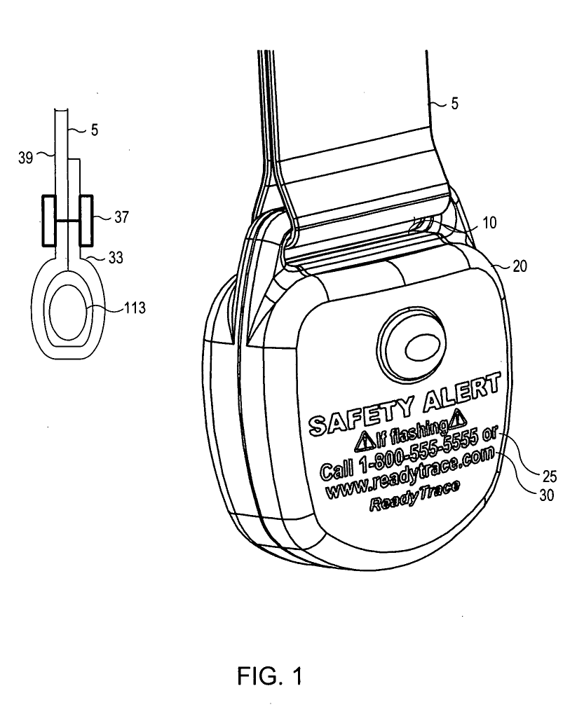

FIG. 1 is a pictorial diagram that illustrates one example embodiment of a product notice receiver in the form of a notifier appendage (a.k.a. a “dongle”). According to this example embodiment, a product notice receiver is fashioned as a dongle 15. According to one alternative example embodiment, the dongle 15 further includes a strap orifice 10. The strap orifice (also known as a “strap loop”) is structured to accept a strap 5. In integration with a product, the strap 5 (which is attached to the product) is inserted into the strap loop 10. As illustrated in figure, the strap is inserted through the strap loop and is double backed 33 onto itself. The inserted end 33 of the strap is affixed along the main portion of the strap that was fed through the strap loop 10. The two portions of the strap 5 are joined together by means of a fasting mechanism 37. In one alternative example embodiment a rivet 37 is used to join the end of the strap 33 back to the main portion 39 of the strap 5. In yet another alternative example embodiment, the end of the strap 33 is adhered to the main portion 39 of the strap 5 by sewing the two portions to each other.

In one alternative example embodiment, the product notice receiver formed as a dongle 15 further comprises a face 20. The face of the dongle 15, includes, according to one alternative example embodiment, a notice that a recall is in fact, e.g. “recall alert” or “safety alert”. In yet another alternative example embodiment, the dongle 15 further includes a marking that provides a telephone number 25 that a user can call in order to obtain more information about a pending recall alert. In yet another alternative example embodiment, the product notice receiver dongle 15 further includes a marking on the face 20 that provides a web site 30 that a user can visit in order to obtain additional information about a pending recall.

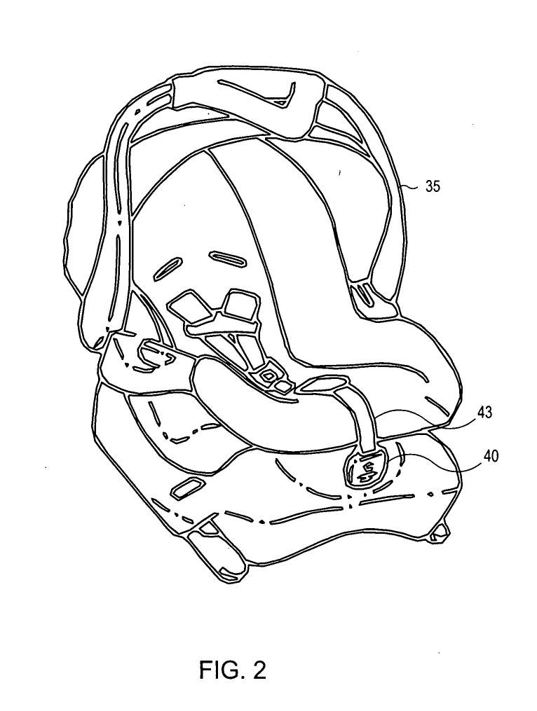

FIG. 2 is a pictorial diagram that illustrates one example illustrative use case for a product notice receiver dongle. According to this alternative example use case, a dongle 40 is attached to a strap 43 which is included in and attached to a baby car seat 35. This is merely one illustrative use case and the claims appended hereto are not intended to be limited in scope to this or any other illustrative use case wherein a product notice receiver toggle is attached to a product by means of a strap 43. For example, other types of products that can be targeted for use with the notifier appendage herein described include, but not limited to a stroller, a baby swing, a crib, a play-pen, a high-chair, a baby-back-pack, and other sundry baby products.

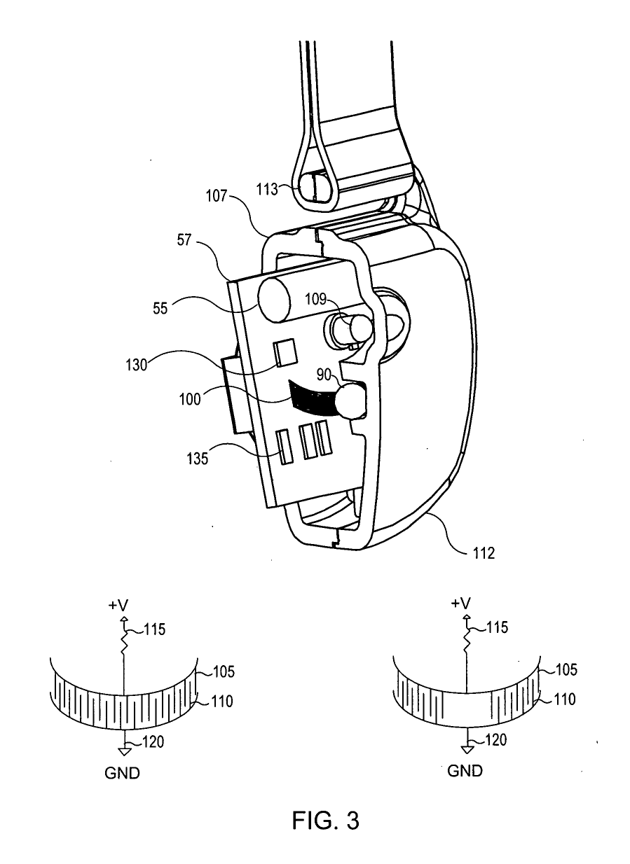

FIG. 3 is a pictorial diagram that illustrates one example alternative embodiment of an internal arrangement of a product notice receiver dongle. According to this example alternative embodiment, a dongle includes a product notice receiver module 57. According to one alternative example embodiment, the product notice receiver module 57 includes an antenna 55. The antenna is used to receive a signal which is then conveyed to a product notice receiver circuit 130. The product notice receiver circuit then drives a light emitting diode or other light source 109, also included in the dongle. According to one alternative example embodiment, the product notice receiver module 57 further includes an in-use detector. In one alternative example embodiment, the in-use detector comprises a motion sensor. In yet another alternative example embodiment, the motion sensor comprises a metallic sphere or other sphere with a conductive surface 90. The metallic surface or the metallic ball 90 is run through a trough (or track-way) that is integrated into one side of a clam-shell case 112 that is used to enclose or otherwise encase the product notice receiver module 57. In operation, the product notice receiver module 57 provides includes a set of the interlocking fingers 105 and 110. A metallic ball or the ball with a conductive surface breaches the fingers of first set of fingers 105 and the second set fingers 110 as it travels through the track-way. When the ball breaches the gap between the fingers 105 and 110, a connection is made thereby indicating that the ball is moving. A connection that is made and broken in rapid succession indicates that the ball is moving through the track which is formed by ribs included in one side of the clam-shell case that forms the dongle. As illustrated in the theater, the first set fingers 105 according to one alternative embodiment are pulled up a power level by means of a resistor 115. The other set fingers 110 are attached to signal ground. Hence, the signal generated by the first second set fingers 105 will alternate from the positive voltage by means of being pulled up by the resistor 115 and “ground” by means of being pulled down to ground 120 as a conductive surface of the ball 90 traverses across the fingers. This signal is then directed to the product notice receiver circuit 130. Included in the circuit 130 is additional circuitry for detecting rapid succession of transitions and the signal generated by the first and second set fingers 105 as the conductive surface of the ball 90 travels through the track 100. In one alternative example embodiment, the front side of the clam-shell 112 is translucent allowing light from the light emitting diode 100 to be visible external to be product notice receiver dongle. This allows the entire assembly to be hermetically sealed as the front side of the clamshell 112 is sonically bonded to the backside of the clamshell 107. Any method of bonding the front and back portions of the clamshell can be used, e.g. glue.

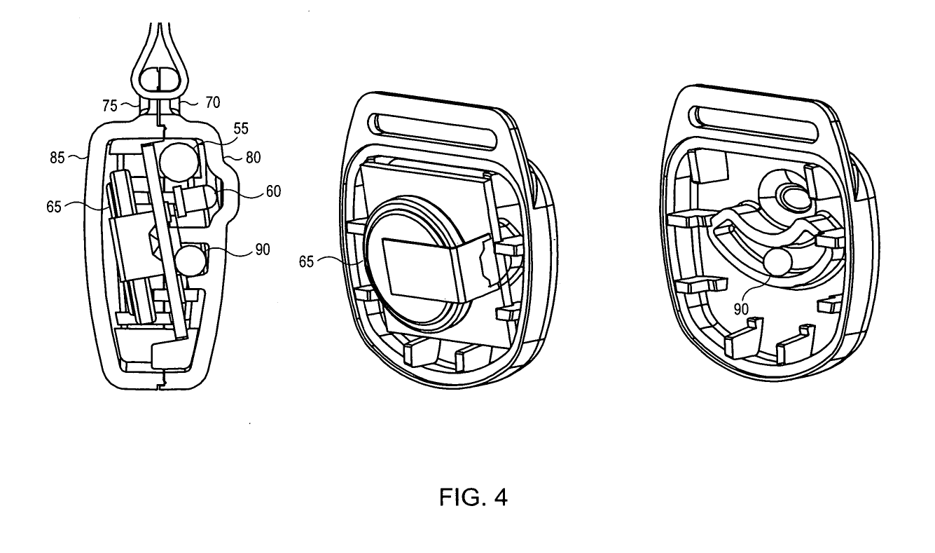

FIG. 4 is a pictorial diagram that illustrates a side assembly view of a product notice receiver dongle. As already described, a product notice receiver dongle includes a product notice receiver module 50. In this alternative example embodiment the product notice receiver module further comprises a power source, for example a battery 65. The battery 65 is used to provide electrical power to the circuit the product notice receiver circuit included in the module 50. The product notice receiver module further comprises a light source (e.g. a light emitting diode 60), an antenna 55 and an in-use detector, for example a motion detector which is constructed using a spherical ball with a conductive surface 90. The ball with a conductive surface 90 is forced against a set of alternating fingers as previously described. The ball is forced against the fingers by means of gravity. It should be appreciated that in a normal operation the module is mounted in a manner where there is a tilt relative to the packaging ensuring that the ball comes in contact with the fingers included in the module 50. According to this alternative example embodiment, markings are transferred onto a front surface of a clamshell that is included in the toggle. A front clamshell 75 completes the assembly and provides for an interlocking assembly between a first interlocking ridge 85 and a corresponding interlocking ridge 80 on the opposite clamshell. The entire assembly is then sonically welded to provide a hermetic seal, thereby preventing moisture and other contamination from reaching the product notice receiver module 50. It should be appreciated that the in-use detector is used by the circuit included in the module 50 in order to prevent unnecessary illumination (i.e. activation) of a light source (light emitting diode 60). This conserves battery power when there is no one around to see the indication.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A product recall notice receiver comprising:
housing that includes a strap orifice;
receiver installed in the housing;
antenna installed in the housing and electrically connected to the receiver;
power source installed in the housing and providing power to the receiver; and
indicator associated with the housing that is actuated by the receiver when a product recall notice is received by the receiver.

2. The product recall notice receiver of claim 1 further comprising indicia associated with the housing that directs a user to contact a manufacturer when the indicator is active.

3. The product recall notice receiver of claim 1 further comprising a motion sensor that detects when the housing is subject to movement and wherein the indictor is actuated when the motion sensor detects such movement.
